(19) United States
(12) Patent Application Publication
(10) Pub. No.: US 2016/0041986 A1
(43) Pub. Date: Feb. 11, 2016

(54) Smart Search Engine

(71) Applicant: Cuong Duc Nguyen, Sacramento, CA (US)

(72) Inventor: Cuong Duc Nguyen, Sacramento, CA (US)

(21) Appl. No.: 14/455,482

(22) Filed: Aug. 8, 2014

(51) Int. Cl. G06F 17/30; G06Q 50/00

(52) U.S. Cl. CPC G06F 17/3053; G06F 17/30864; G06F 17/30554; G06Q 50/01

(57) ABSTRACT

The subject disclosure presents methods and systems for implementing a smart search engine (SSE). The SSE allows users input a natural language query, parses the query, searches for the most proper entity (or relation) from a Knowledge Base, shows the found entity (or relation) with its semantic-rich refinements, and displays the search results sorted by a proposed ranking function. Search results include a list of Web documents that are semantically indexed by the queried entity (or relation). Users can refine their query by exploring several semantic refinements that provide semantically related information of the currently searched entity (or relation). The SSE uses a Knowledge Base to store semantic knowledge that is extracted from the semantic analysis of Web documents. Methods to construct, maintain and evolve the Knowledge Base are also described.

### BACKGROUND OF THE SUBJECT DISCLOSURE

1. Field of the Subject Disclosure

The subject disclosure relates to search engines. Specifically, the subject disclosure relates to natural language processing of search queries using refinement and semantic indexing.

2. Background of the Subject Disclosure

The majority of search engines on the Internet today, such as GOOGLE®, YAHOO!®, BING®, etc. rely mainly on keyword searching. These search engines extract keywords from a query submitted by a user at a client terminal, and search the extracted keywords using index databases to find related links as search results. The keyword-based approach is limited in terms of query input, query processing, and document indexing. For instance, keyword-based search engines only extract main keywords from an input query as their basic units, and discard all other words that are often called “stop words.” Valuable information such as the word order in the query, the form of words, the syntactic role of words, etc. is abandoned. Thus, this keyword-focusing method has limited the input capability of queries. In fact, search-engine users have recognized this limit, and often input their query as a set of isolated keywords without any order, which is a trend away from a natural-language question. Even if a natural-language question is input as a query, existing keyword-based search engines cannot fully understand the user's intention in the query. Therefore, existing search engines are severely constrained in their ability to process a query.

Moreover, there are existing limitations with query processing and returning results. After extracting keywords, existing keyword-based search engines search keywords in indexing databases to find related links. For example, a related link may comprise a URL (Uniform Resource Locator) referring to a Web address storing a Web document that includes inputted keywords. Aliases, i.e. equivalent names of a keyword, may also be used in searching. However, the meaning of keywords is not processed in the searching process of these search engines. After searching in indexed databases, millions of links are often returned that directly match the keywords, without any semantic searching on databases. Keywords including proper nouns may refer to more than one entity, such as “Java” being used to name an island in Indonesia as well as a programming language in computing. The search results related to these entities are merged together. Processing keywords without caring about the relation between keywords in the query also reduces the search quality. For example, when a user inputs a query “red apple”, keyword-based search engines treat “red” and “apple” as two independent keywords, but the true intention of the query is a compound noun of “red apple.” The results are also not provided in an order that is based on the meaning of the query. The list of returned links may be ranked by ranking methods, such as the well-known PageRank method. The PageRank method ranks a Web document by the significance of that page. Thus, in such methods, the relationship between a page and the whole query is not fully integrated in ranking methods. There are some improvements in the ranking method with the user modeling, including the location, the query history, etc., of the current user; with named entity recognition; or with the meta-data of a page. However, the current ranking methods remain unsatisfactory.

Further, existing indexing methods of documents in keyword-based search engines is based on the well-known Latent Semantic Indexing method that fails to consider the semantic structure of an input query or input document. In Latent Semantic Indexing, a natural-language document is analyzed to extract main keywords, and each keyword is transformed to its rooted form and weighted by a statistical measure, e.g. term frequency/inverse document frequency (TF/IDF). A vector of these weighted keywords is used to represent the document in applications. In a search engine, for instance, documents with keywords matching the queried keywords can be returned as search results. An indexing database of the inversed index may be constructed by crawling and analyzing all pages on the Internet. The indexing database is mainly used in searching documents for a given set of keywords. Despite wide usage of Latent Semantic Indexing, this method discards or fails to consider several meaningful features of the analyzed document.

Moreover, when searching a compound noun or a phrase consisting of several keywords, keyword-based search engines independently find extracted keywords in the indexing database, and then combine the findings. The combination of findings is therefore unrelated to the syntactic order and role of those keywords in the original query, so that the returned results do not match the user's intention in generating the query. Moreover, search engines measure frequently-searched compound nouns or phrases as pre-defined keywords. Although this enables searching for complex keywords, there are a huge number of compound nouns or phrases that have to be indexed, so that it significantly increases the size of the indexed database, and search processing times.

There have been some attempts in semantically improving search engines, although even these are inadequate. Some semantic search engines allow users input a natural-language query and match semantic segments of the query with known patterns. Entity-based search engines may match an entity that matches to the keywords extracted from the query, with the matched entity being treated as the core search term, and its main features and associations being displayed in a form similar to an info-box of WIKIPEDIA®. However, such search engines construct their entity databases mostly based on Linked Open Data, such as DBpedia or Wikipedia that are manually edited and slow to change. In addition, the search results of entity-based search engines are not very different from keyword-based search engines because of the usage of the same indexing process.

### SUMMARY OF THE SUBJECT DISCLOSURE

The subject disclosure addresses the above-identified concerns by presenting a smart search engine (SSE) that allows a user or client to input a natural-language query, such as a phrase, sentence, or plurality of sentences, and to receive relevant results. The SSE includes a natural language processing engine (NLPE) to analyze an input query and to generate a semantic structure for the query. For instance, a semantic structure may represented by one or more tuples (T1, T2, T3, T4, T5, T6), with each value representing a subject, a verb, a direct object, an indirect object, a supplement, and a type of the input query. The SSE examines the semantic structure to identify a search type. The search type may be an entity search, a relation search, or a supplement search. For entity searches, the SSE may identify a set of entities that match the main queried entity. A default entity may be designated from this resulting set of entities based on a statistical measurement. For relation searches, the SSE may identify a set of relations that match the queried relation. A default relation may be designed from the resulting set of relations based on the statistical measurement. For supplement searches, the SSE may identify meta-data about facts that satisfy the query. Examples of meta-data include a place, a time, a purpose, etc. A search is then performed for any links or documents that are indexed based on the default entity. The index may be stored in a knowledge base (KB) that is accessible locally or via a network. Any matching indexed links are returned along with the default entity or default relation as a search result. Further, the KB may be constructed and may evolve based on the operations performed by the SSE.

The knowledge base (KB) enables the SSE to perform several semantic-rich refinement operations. Refinement operations may enable a user to select one or more listed features or refinements based on related or additional entities, to further refine the results. Indexing operations may include semantic indexing operations for analyzing documents or pages downloaded from public networks to construct an indexing system. The semantic indexing operation may further comprise executing the NLPE to parse a document and extract semantic structures, and constructing the indexing system from entities, relations, and categories from the retrieved documents. Finally, a ranking operation may be executed to sort the returned search results according to information from a plurality of sources. Further, returned links may be tagged with annotations to recommend interesting web pages to users. The annotations may be based on additional characteristics of the linked page, for instance based on popularity, date modified, etc. These features for ranking a page may be used in addition to the semantic relation of the linked page to the input query, with stronger relations being ranked higher on the list.

### BRIEF DESCRIPTION OF THE DRAWINGS

FIGS. 1A and 1B show a system infrastructure and logical modules of a smart search engine (SSE), according to an exemplary embodiment of the subject disclosure.

FIG. 2 shows a knowledge base, according to an exemplary embodiment of the subject disclosure.

FIG. 3 shows components of a smart search engine, according to an exemplary embodiment of the subject disclosure.

FIGS. 4A-4B show screen shots of the SSE interface when the main search result is an entity and a relation, respectively, according to exemplary embodiments of the subject disclosure.

FIG. 5 shows a method for smart searching, according to an exemplary embodiment of the subject disclosure.

FIG. 6 describes a method for indexing, according to an exemplary embodiment of the subject disclosure.

### DETAILED DESCRIPTION OF THE SUBJECT DISCLOSURE

The subject disclosure addresses the above-identified concerns by presenting a smart search engine (SSE) that allows a user or client to input a natural-language query, such as a phrase, sentence, or plurality of sentences, and to receive relevant results. The SSE utilizes a natural language processing engine (NLPE) to analyze an input query and to generate a semantic structure for the query and any component clauses within the query. The semantic structure generally describes a main queried entity and any relations, any referenced entities, and relations between entities. The NLPE may include a plurality of modules for statistically parsing the input query to identify the syntactic structure of the query, and to generate the semantic structure. For instance, a semantic structure may be in the form of a tuple (T1, T2, T3, T4, T5, T6), with each value representing a subject, a verb, a direct object, an indirect object, a supplement, and a type of the input query. The NLPE is described in further detail in commonly-assigned and co-pending U.S. patent application Ser. No. ______/______, the contents of which are hereby incorporated by reference herein in their entirety.

The SSE examines the semantic structure to identify a search type. The search type may be an entity search, a relation search, or a supplement search. For entity searches, the SSE may identify a set of entities that match the main queried entity. An entity, as used herein and throughout this disclosure, refers to a known named entity such as a specific person, e.g. “George Bush”, or a particular instance of a common noun, e.g. “president” or “apple.” A single named entity may be referred to by more than one name, e.g. “President Bush,” “George H. Bush,” or “President George Bush” may all refer to the same entity. Moreover, a single entity within a document or web page may be understood as referring to more than one named entity, e.g. “George Bush” may refer to “George H. Bush,” “George W. Bush,” or any other George Bush. Therefore, the disclosed SSE selects a default entity based on the statistical measurement of the resulted set of entities. For relation searches, the SSE may identify a set of relations that match the queried relation. For supplement searches, the SSE may identify meta-data about facts that satisfy the query. A set of matched entities may be returned from the entity search, from which the SSE may select a default entity. A search is then performed for any links or documents that are indexed based on the default entity. The index may be stored in a knowledge base (KB) that is accessible locally or via a network. Any matching indexed links are returned along with the default entity as a search result. Further, for the relation or supplement searches, the SSE applies a similar method for displaying the search results. Further, the KB may be constructed and may evolve based on the operations performed by the SSE. For instance, the KB may initially be constructed from known semantic resources, including information of entities and their relations collected via an analysis of web documents or other sources. This information may be initially indexed. Further, the index of entities and relations within the knowledge base may be adjusted automatically based on new results returned. User feedback and expert inspection may be enabled to edit entities and their relations.

The knowledge base (KB) enables the SSE to perform several semantic-rich refinement operations. For instance, an ambiguity-refinement operation clarifies a determination of an appropriate entity that matches the intention behind the input query. A social refinement operation retrieves documents or pages related to the default entity from social networks. A feature refinement operation enables a user to select one or more listed features of the default entity to refine the query based on a value of the selected features. A similarity refinement operation provides similar entities to the default entity. Association refinement operations use relations between entities to provide additional entities that are associated with the default entity, enabling a user to explore information related to the default entity. Specific refinement operations display more particular entities of the default entity, and general refinement operations display more general entities of the default entity. These refinement operations provide a contextual view of the default entity, i.e. enabling a user to view the default entity within the context of several additional entities.

Indexing operations may include semantic indexing operations for analyzing documents or pages downloaded from public networks to construct an indexing system. The semantic indexing operation may further comprise executing the NLPE to parse a document and extract semantic structures, and constructing the indexing system from entities, relations, and categories from the retrieved documents.

The SSE includes a ranking operation to sort the returned search results according to information from a plurality of sources. For instance, a popularity of a web page based on unique hits, a belief level of a page indicating how accepted the page is among experts, an information richness of the page based on a number of mentioned entities, an entity-document relation measuring a strength of a link between the main queried entity and the document, and a user evaluation of the entity-document relation based on a user's selection of a returned link may be among several factors used by the SSE to rank the results. Further, returned links may be tagged with annotations to recommend interesting web pages to users. The annotations may be based on additional characteristics of the linked page, for instance based on popularity, date modified, etc. These features for ranking a page may be used in addition to the semantic relation of the linked page to the input query, with stronger relations being ranked higher on the list.

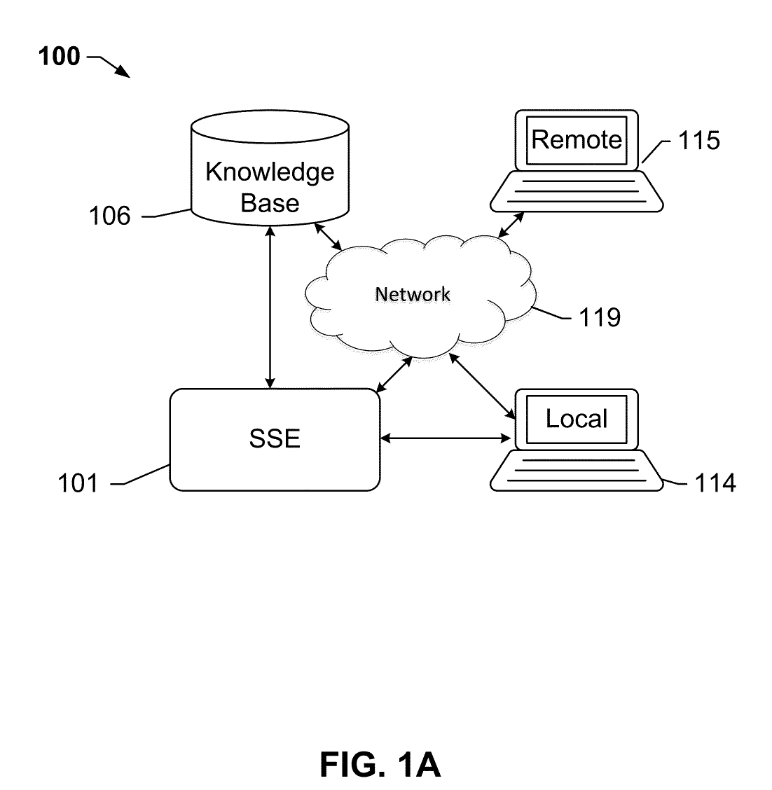

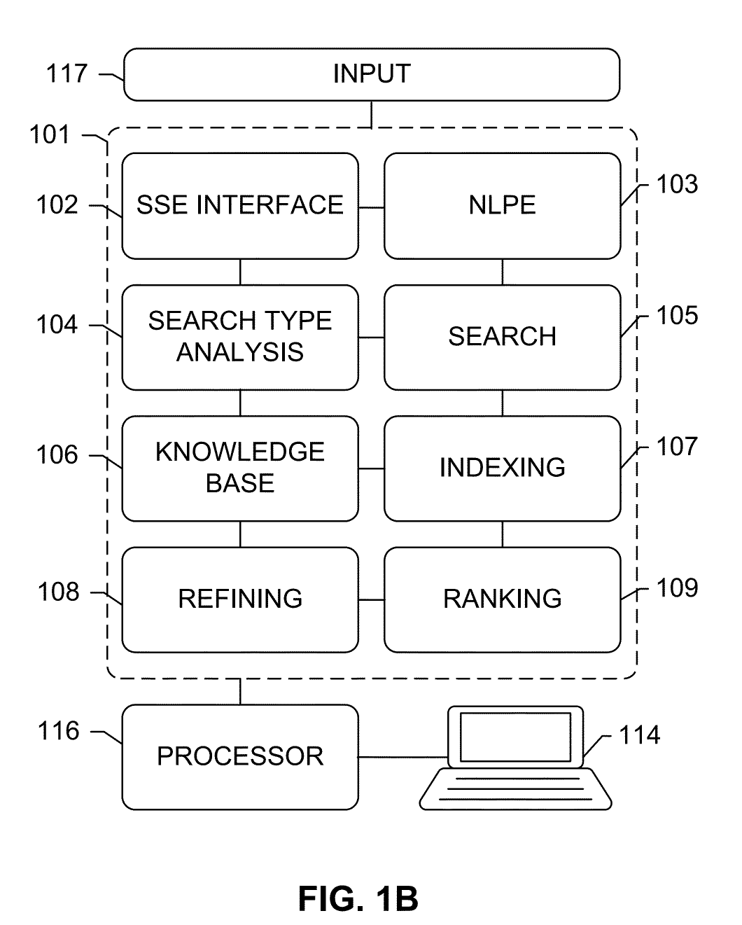

FIGS. 1A and 1B show a system and logical modules of a smart search engine (SSE), according to an exemplary embodiment of the subject disclosure. FIG. 1A shows a system infrastructure for enabling the operations disclosed herein, whether locally or remotely using a network. FIG. 1B shows the logical components of a smart search engine, according to an exemplary embodiment of the subject disclosure. With reference to FIG. 1A, an exemplary computer network system 100 comprises a smart search engine (SSE) 101 in communication with a local client terminal 114, as well as with a remote client terminal 115 and a knowledge base 120. SSE 101 receives a query from either local client terminal 114 via a direct connection, or from remote client terminal 115 via, for instance, a network 119. To process the query as described herein, SSE 101 may refer to knowledge base 120, either locally or via network 119.

Each of client terminals 114 and 115 may be representative of many diverse computers, systems, including general-purpose computers (e.g., desktop computer, laptop computer, etc.), network appliances (e.g., set-top box (STB), game console, etc.), and wireless communication devices (e.g., cellular phones, personal digital assistants (PDAs), pagers, or other devices capable of receiving and/or sending wireless data communication). Further, each of client terminals 114 and 115 may include one or more of a processor, a memory (e.g., RAM, ROM, Flash, hard disk, optical, etc.), one or more input devices (e.g., keyboard, keypad, mouse, remote control, stylus, microphone, touching device, etc.) and one or more output devices (e.g., display, audio speakers, etc.). Moreover, each of client terminals 114 and 115 may be equipped with a browser stored in a memory and executed by a processor. The browser may facilitate communication with SSE 101 through network 119 or via a local connection. One or more components of SSE 101 may be locally executable on either client terminal 114 or 115.

FIG. 1B shows the logical modules of SSE 101, according to an exemplary embodiment of the subject disclosure. In the illustrated implementation, SSE 101 may comprise one or more logical units that are capable of receiving an input query 117 from one or more clients 114, processing the request using processor 116, and returning the appropriate results. The modules may be executed in any sequence to provide search results based on an input query. For instance, input query 117 may be submitted via an interface generated by SSE interface module 102. The input query 117 may be submitted via a terminal, such as terminal 114, or from a remote client that is provided access to or that can execute SSE interface module 102. The input 117 may be a natural-language query comprising information related to one or more entities or relations. During the input of the query, SSE interface 102 may parse any received portion of the input in real-time and may generate recommendations for popular entity or relation names. The recommendations may be based on reference to a database of names, such as a name dictionary, as further described herein.

The complete submitted query is received at Natural Language Processing Engine (NLPE) module 103. NLPE 103 parses the user query to generate a semantic structure for the query, as is further described in commonly-assigned and co-pending U.S. patent application Ser. No. ______/______. Briefly, the input sentence may be parsed to generate a plurality of syntactic structures at multiple levels, such as a sentence-level, a phrase-level, and an entity level. The phrase-level syntactic structure may be generated by recognizing one or more main and sentence-level subordinate clauses within an input sentence. For each clause, a phrase-level record may be generated to store the main parts of the clause. The phrase-level record may comprise a tuple of syntactic structures corresponding to various grammatical elements of the corresponding clause, such as subjects and objects, as well as a type of clause. For instance, the phrase-level record may be a tuple of (P1, P2, P3, P4, P5, P6), in which, P1, P2, P3, P4 and P5 may represent the syntactic structures of the subject part, the verb part, the direct object, the indirect object and the supplementary part of the clause, respectively, and P6 storing the type of the clause, such as “Main” or “Subordinate”. A verb record may also be generated, comprising information about verb phrases within the clause such as the current surface form of extracted verb, stemmed form of the extracted verb, verb tense, positive or negative form, active or passive voice, etc. An entity-level syntactic structure may be based on noun and prepositional phrases in the corresponding part of the tuple. For instance, noun phrases and prepositional phrases in P1, P3, P4 and P5 of the phrase-level syntactic structure may be used to construct the entity-level syntactic structure. In each noun phrase, a plurality of entities may be recognized, and each entity is linked to a corresponding entity or set of corresponding entities in an external knowledge base. The entity-level syntactic structure may be considered an expansion of the phrase-level syntactic structure in that each P1, P3 and P4 of a phrase-level record may be attached with, linked to, or otherwise associated with a set of entities. Prepositional phrases in P5 of each clause may also be processed at this time to extract the supplement part of the clause. Finally, the entity-level syntactic structure may be analyzed to generate a sentence-level semantic structure that is based on a set of candidate entities that are determined by a co-reference resolution operation and links determined between the plurality of phrases. The filtered set of candidate entities and links may be combined to create a final set of tuples (T1, T2, T3, T4, T5, T6), in which, T1, T3 and T4 are entities in the external KB, T2 is a verb in the KB, T5 is the supplement information of the tuple, and T6 is the type (e.g., “main” or “support”) of the tuple. The sentence-level semantic structure comprising the final set of tuples may be analyzed by the additional modules comprised by SSE 101 in order to process the query.

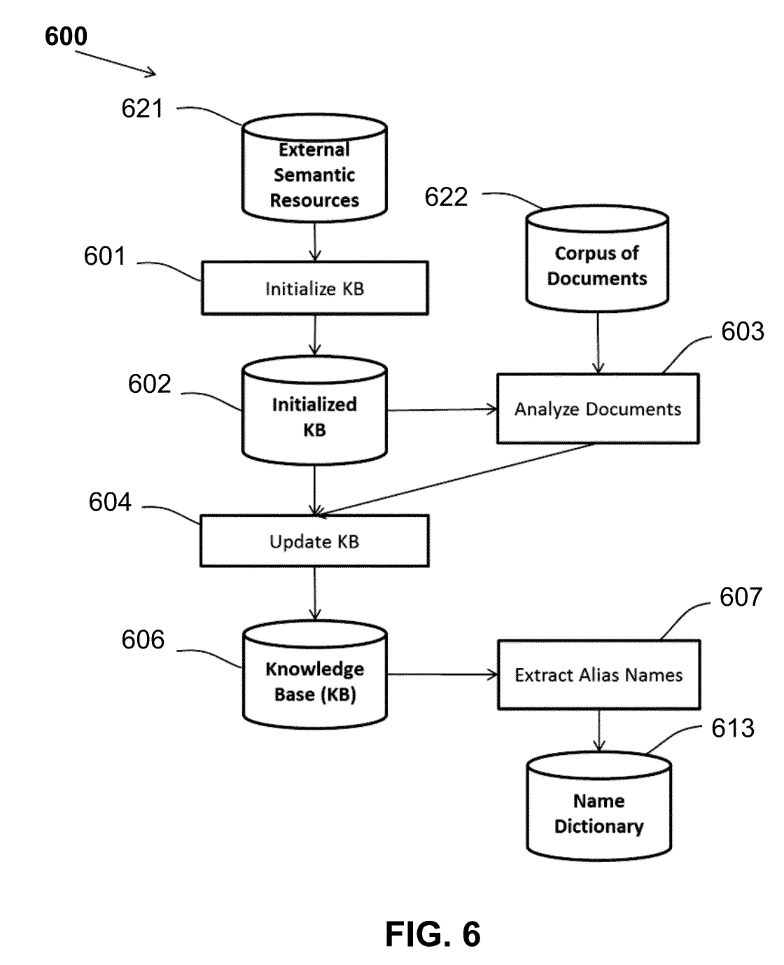

For instance, a search type analysis module 104 may be executed to determine, based on the semantic structure of the query, a type of search to be performed. The type of search may be determined by matching one or more tuple templates (FIG. 6) with the semantic structure of the query. Depending on which tuple templates match the query, search type analysis module 104 may invoke one or more of a search known entity operation, a search unknown entity operation, a search relation operation, or a search supplement operation. The determination of search type is submitted to a search module 105. Search module 105 may be executed to match entities or relations in the query with entities or relations in a knowledge base (KB) 106. For instance, knowledge base 106 may comprise a plurality of indices corresponding to entity names, relations, etc. Based on the results, search module 105 may return a plurality of entities, from which a default entity may be designated based on statistical measures of the returned results from KB 106. Search results may be returned to SSE interface 103 to be displayed to a user.

KB 106 includes a plurality of data structures and indices that may be generated and/or updated by indexing module 107. Indexing module 107 imports the content of external semantic resources, such as public databases electronic encyclopedias, and other documents, to create an initialized knowledge base. For instance, the external semantic resources may be crawled from the Internet. After the creation of the initialized knowledge base, indexing module 107 may invoke NLPE 103 to extract semantic tuples from the plurality of external semantic resources. The extracted semantic tuples may be imported into and used to modify the initialized knowledge base, resulting in KB 106. Moreover, indexing module 107 may extract names of entities and relations to create a name dictionary that may be used to recommend proper terms to users while inputting a query 117.

Refining module 106 may be executed to clarify a determination of an appropriate entity that matches the intention behind the input query by using social refinement, feature or attribute refinement, similarity refinement, association refinement using relations between entities, and specific and general refinements for displaying additional entities. Refining module 106 returns results to SSE interface 103 to enable a user to explore information related to the default entity, and receives selections of refinements from the user via SSE interface 103. The selections may be used to generate a new or additional query.

Ranking module 109 may be executed to rank the search results based on a combination of one or more of a well-known factor of a page or the semantic related measurement between a queried entity/relation and a page. The well-known factor of a page is independent from the query, and therefore may be stored in a database of page address. The related measurement between a queried entity/relation and a page is stored as a meta-data of the index from an entity or a relation to a document.

SSE 101 may be hosted on a server or a server environment, such as a server for a local area network or wide area network, a backend for such a server, or a Web server. In this latter environment of a Web server, the logical components of SSE 101 may be implemented as one or more computers that are configured with server software to host a site on the Internet, such as a Web site for the provided service. The server that hosts SSE 101 may include a processor 113, a memory (e.g., RAM, ROM, Flash, hard disk, optical, RAID memory, etc.). For purposes of illustration, the modules comprised by SSE 101 are only illustrated as discrete blocks stored in a memory, although it is recognized that such programs and components reside at various times in different storage components and may be distributed across a plurality of servers.

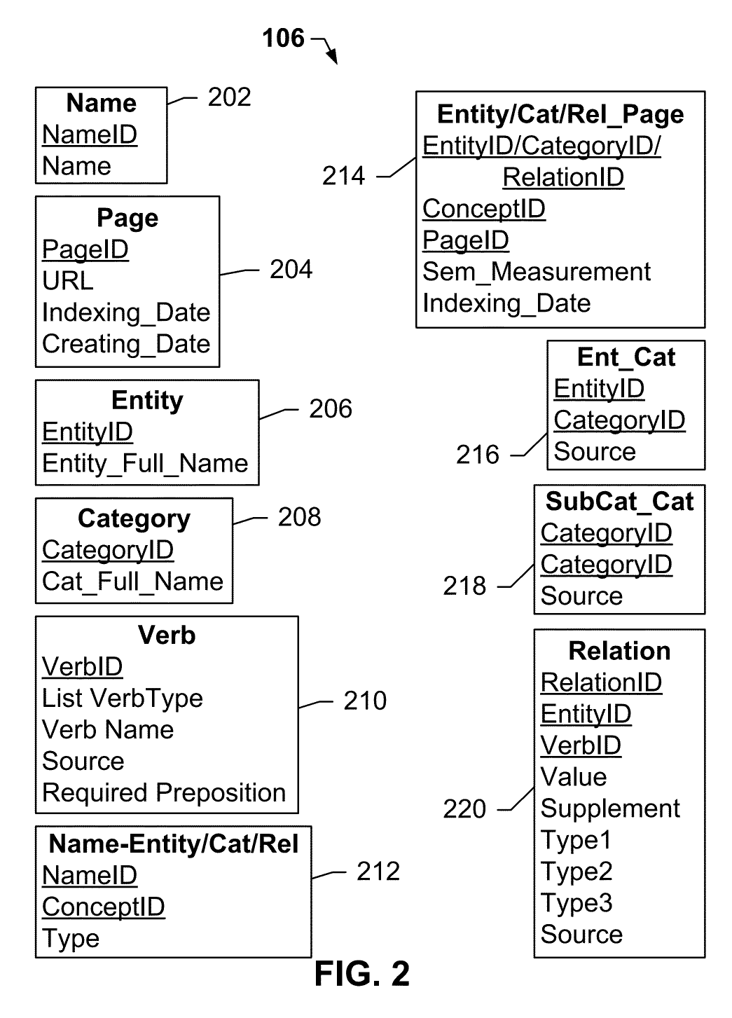

FIG. 2 shows a knowledge base, according to an exemplary embodiment of the subject disclosure. As described herein, an SSE refers to a knowledge base (KB) to perform entity recognition and other operations. With reference to FIG. 2, KB 106 comprises a plurality of tables and a corresponding plurality of records within each table. An exemplary table and record layout is shown, and any other layout may be appreciable by those having ordinary skill in the art in light of reading this disclosure and without detracting from the inventive spirit and scope of this disclosure. For instance, name table 202 stores one record for each determined name of an entity, a category or a relation. Page table 204 stores one record for each indexed web document. Entity table 206 stores one record for each concept that is a proper noun or a common noun. Category Table 208 stores one record for each determined category. Verb table 210 stores one record for each determined verb. Entity/Category/Relation table 212 stores one record for each name, as identified by the NameID field from the Name table 202, that is mapped to a concept, identified by the ConceptID field. The “type” column in table 212 specifies whether the ConceptID can be an EntityID, for instance, when “type=1”, a CategoryID, for instance when “type=2”, or a Relation ID, for instance, when “type=3”. The Entity/Category/Relation table 214 stores one record for each index determined from an entity, a category, or a relation, to a document. For instance, the entity may be identified by the EntityID field in table 206, a category may be identified by the CategoryID field in table 208, and a relation may be identified by the Relation ID field in table 214. The Entity_Category table 216 stores one record for each relation that is determined to belong from an entity, as identified by the EntityID field, to a category, as identified by the CategoryID field. The SubCat_Cat table 218 stores one record for each relation that is determined to belong to a sub-category from a category. Finally, relation table 220 stores one record for each determined concrete relation of (EntityID, VerbID, Value). For instance, the Type1 field specifies whether the Value can be an EntityID (when Type1=1) or a real-world value (when Type1=2). Similarly, the Type2 field specifies whether this record is created in the initialization phase of the KB (when Type2=1) or in the updating phase of the KB during learning via analysis of several documents (when Type2=2). The Type3 field specifies whether this record represents an inclusive property of the source entity (when Type3=1) or an exclusive property of the source entity (when Type3=2). The supplement field stores additional information of the relation. Moreover, it should be understood that although the tables are shown representing the depicted data structures, additional data may be stored in each table.

For each table in KB 106, the underlined column in a table is the key column. Each table can have some additional meta-data. KB 106 may be considered an expanded or improved version of existing knowledge bases or data repositories such as electronic encyclopedias. For instance, in Wikipedia®, one entity has a unique name and one corresponding page, but in the KB 106, one name can refer to several entities and several names can refer to one entity. This relation may further be specified by the Name-Entity/Cat/Rel table 212. In KB 106, one entity may further be indexed in several pages, and this indexing may be specified by the Ent/Cat/Rel_Page table 214. The relations from an entity to a category and between categories may be analogous to those in existing knowledge bases such as Wikipedia. However, the information retrieval mechanism in KB 106 is different than with other general knowledge repositories. For instance, a query submitted to KB 106 is treated as a search on a name with or without a corresponding type. From the returned list of ConceptIDs in the Name-Entity/Cat/Rel table 214 and the corresponding type, other relevant information can be retrieved from the KB 106.

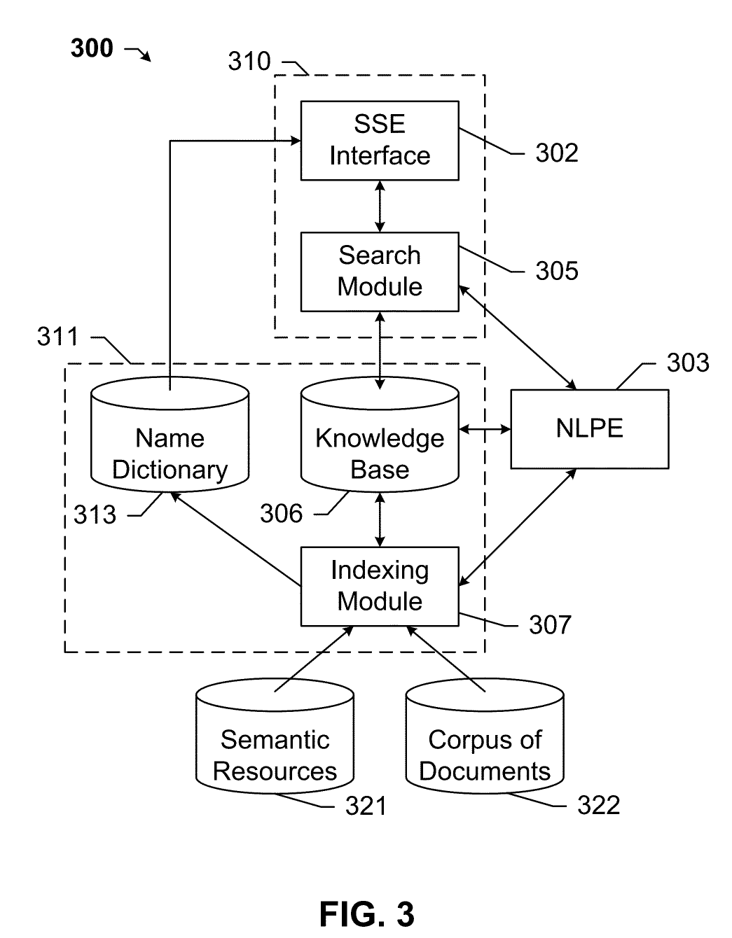

FIG. 3 shows components of a system for a smart search engine, according to an exemplary embodiment of the subject disclosure. According to the embodiment in FIG. 3, a system 300 includes a searching subsystem 310, an indexing subsystem 311, and an NLPE 303. Searching subsystem 310 receives a user query that it processes and applies on knowledge base (KB) 306, in order to provide relevant search results. Indexing subsystem 311 analyzes external references such as semantic sources 321 and a corpus of documents 322 to create KB 306 and other databases such as a name dictionary 313.

Within search subsystem 310, an SSE interface 302 is provided for enabling a user to search for documents related to specific entities or relations by inputting a natural-language query comprising information describing a queried entity or relation. While receiving the input, SSE interface 302 recommends, in real-time, popular entity or relation names that are similar to any input portion of the query. The recommendations may be provided by matching any input portion of the query with names in name dictionary 313. A completed query is then forwarded to search module 305. Search module 305 invokes NLPE 303 to request a semantic structure for the query. NLPE 303 parses the query and returns the semantic structure that may comprise a set of tuples (T1, T2, T3, T4, T5, T6), in which, T1, T3 and T4 are entity IDs in KB 306; T2 is a relation ID in KB 306; T5 is supplement information of the tuple; and T6 is the type (e.g., “Main”, “Subordinate”, “Query”), respectively.

Search module 305 uses these tuples to search for matching entities or relations within KB 306. For example, if more than one matching entity is found from KB 306, search module 305 selects one entity as a “default entity” based on statistical information related to the results from the tuple matching. Any information related to the default entity is retrieved from KB 306 and provided to SSE interface 302 to be displayed to the user as refinements that may be selected or deselected to refine the results. The search results, as indices to Web addresses, are also retrieved from KB 306 and provided to SSE interface 302. The user may input a new query or select one of refinements as the next query.

Indexing subsystem 311 comprises an indexing module 307 that is executed to import the content of a plurality of external semantic resources 321 to create an initialized knowledge base. After the creation of the initialized knowledge base, indexing module 307 invokes NLPE 303 to extract semantic tuples from documents in the corpus of documents 322. Indexing module 307 uses extracted semantic tuples to adjust the initialized knowledge base and to create a knowledge base 306. Documents in the corpus of documents 322 may be crawled from the Internet. Indexing module 307 also extracts the names of entities and relations from resources 321 and documents 322 to create and update name dictionary 313, which is used to recommend proper terms to users while inputting a query via SSE interface 302.

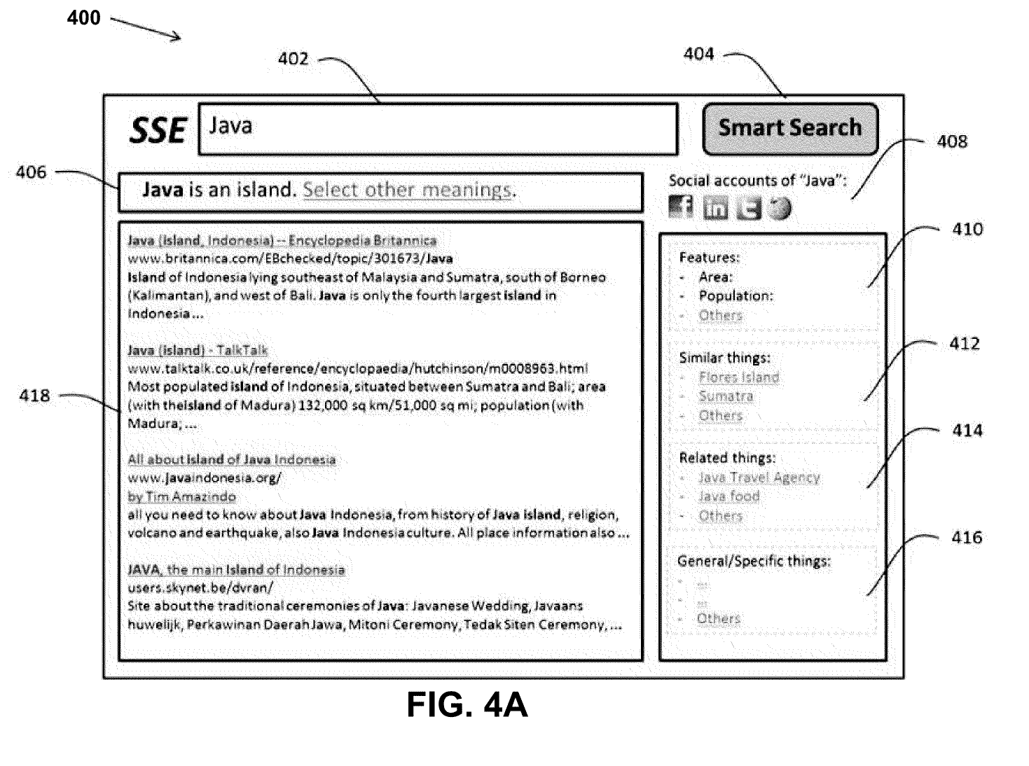

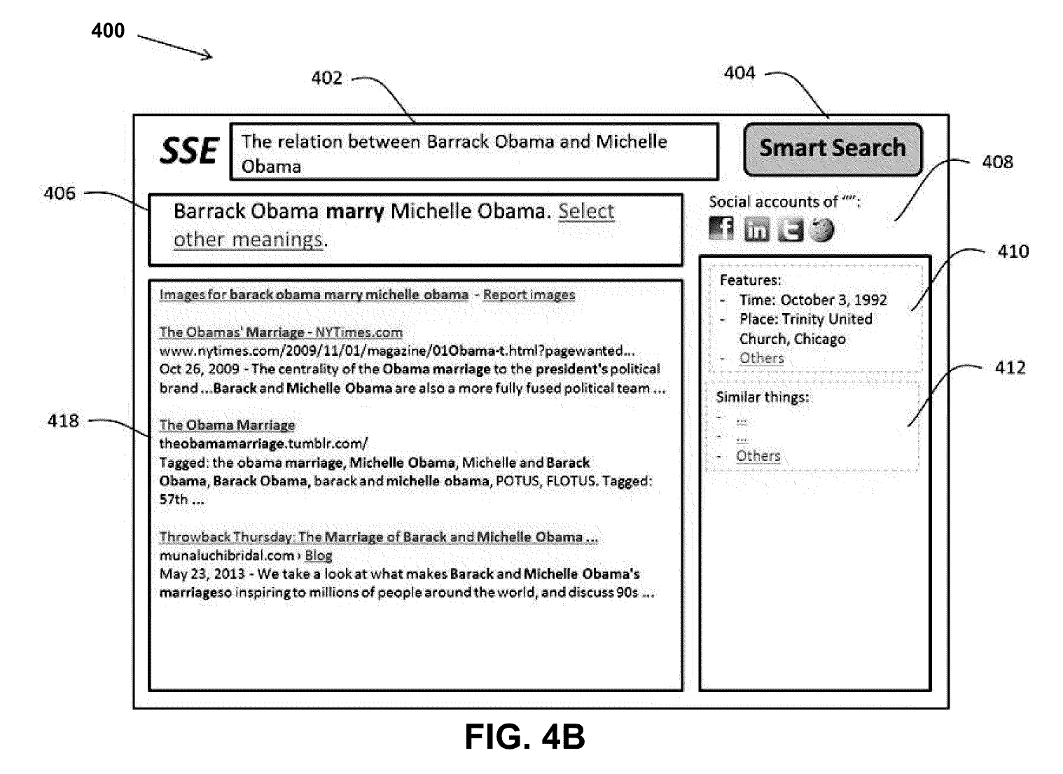

FIGS. 4A-4B show screen shots of the SSE interface when the main search result is an entity and a relation, respectively, according to exemplary embodiments of the subject disclosure. In both figures, a user interface 400, provided by a search interface module or software application on a terminal, includes a query field 402 and a search button 404. Query field 402 receives a query input by a user at the terminal, and search button 404 initiates the execution of a search module. Query field 402 displays an exemplary query, for instance the word “Java” in FIG. 4A. Disambiguation area 406 displays the default entity as selected by the SSE, and a link to a list of ambiguous entities. Clicking the link pops up a list of ambiguous entities that may be related to the queried entity, and options for a user to refine the list of entities based on a plurality of refining operations disclosed herein. For example, an ambiguous entity may have an identical name but different meaning than the default entity. Further, a social refinement area 408 displays social links that, when clicked, lead to pages related to the default entity discovered on social networks. A feature refinement area 410 displays the features of the default entity, such as attributes of the “Java” island. A similarity refinement area 412 displays entities that are similar to the default entity. Association refinement area 414 displays entities associated with the default entity. Specific and General refinement area 416 displays more specified entities of the default entity such as regions within a Java island, political entities, etc., or generalized entities of the default entities, such as surrounding regions, other islands, links related to Indonesia, etc. A main display area 418 displays search results including popular links, hot links and text-search results. FIG. 4B shows similar areas for a relational search, e.g. between two entities “Barack Obama” and “Michelle Obama” results in a default relation of “marriage” being provided as a result, and options to select alternative or refined entities similar to those in FIG. 4A. It should be noted that these interface screenshots are merely exemplary and other layouts and designs may be conceived by those having ordinary skill in the art, in light of the disclosed exemplary embodiments.

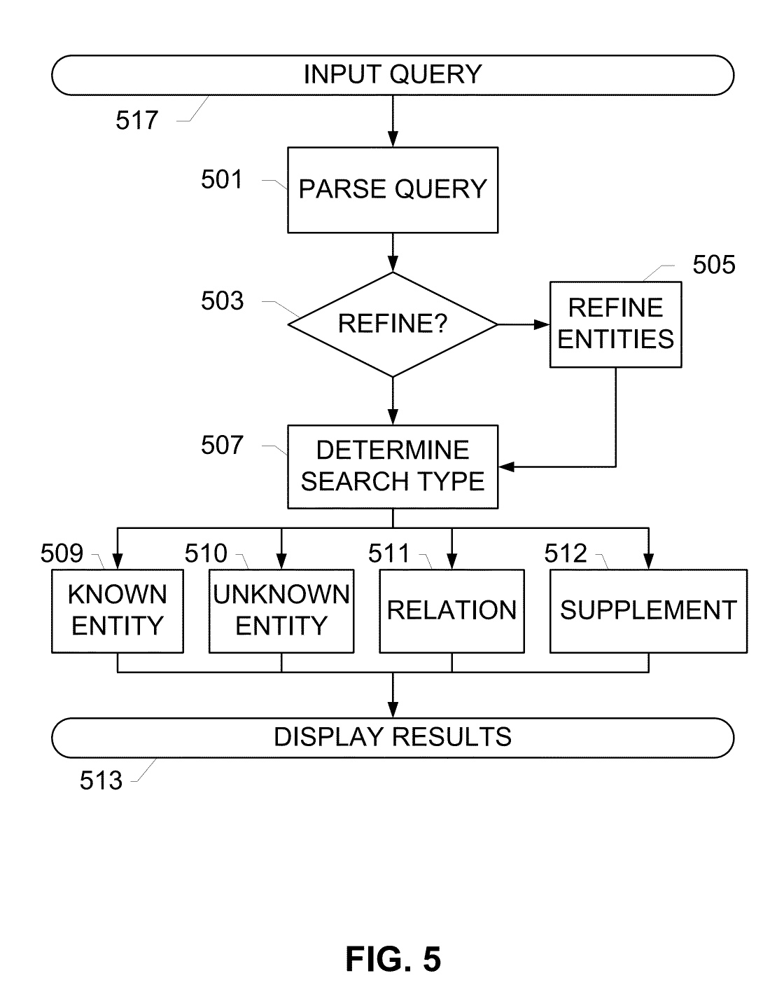

FIG. 5 shows a method for smart searching, according to an exemplary embodiment of the subject disclosure. Although discrete method steps are shown, the operations described herein may be paired or grouped differently depending upon the source sentence/query, or may be performed in a different order, so long as the inventive scope and spirit is preserved. The exemplary method may begin with a query being input 517, for instance at a terminal including a processor for executing an SSE interface as described above. The query may comprise a natural language question along with additional information or context. For instance, the additional information or context may include additional sentences or statements that provide more information about the queried entity or relation. Basically, query can comprise any combination of entities and relations in the form of phrase, sentences, paragraphs, or documents. The query is parsed 501 to extract entities and semantic structures. As described above, the query may be parsed in real-time as it is input, with entities being matched with a name dictionary, and suggestions for additional entities or alternate entities being provided to a user as the query is being input 517. Further, a completed query is submitted to an NLPE to be parsed 501 to enable generation of a semantic structure for the query. The semantic structure may comprise a set of tuples (T1, T2, T3, T4, T5, T6) as described herein. Moreover, refinements may be displayed on the SSE interface, enabling a user to refine entities matched from the semantic structure and a knowledge base. If refinements are selected 503 by the user, then the entities are refined 505 as described herein. In some embodiments, the refinements may be provided after a determination of a search type 507. In either case, a search type determination 507 compares the semantic structure of the query with a plurality of tuple templates to determine a match, if any. Exemplary tuple templates are described below in Table 1. Depending on the results of the matching, one or more search methods are selected between a known entity search 509, unknown entity search 510, relation search 511, or supplement search 512. Each search operation 509-512 comprises comparing entities and relations extracted from the semantic structure of the query with a knowledge base (KB) to retrieve matches. After searching the KB by applying one of methods 509-512, search results are displayed on the SSE interface 513. A user may select refinements 503 at this point as well, with refinements being used to generate a subsequent search query that is again determined as a type 507 and processed accordingly.

TABLE 1

| Query Type | Exemplary Tuple Templates |
|---|---|
| Who/What | (EntityID of “who”, VerbID of “be”, “*”, “none”, |
| is . . . ? | “*”, “Query”) |
| | (EntityID of “what”, VerbID of “be”, “*”, “none”, |
| | “*”, “Query”) |
| Who did/ | (EntityID of “who”, VerbID of verb, “*”, “*”, “*”, |
| does . . . ? | “Query”) |
| Who/Whom . . . ? | (“*”, VerbID of verb, EntityID of “whom”, “*”, “*”, |
| | “Query”) |
| Relation | (“*”, VerbID of “do-what”, “*”, “*”, “*”, |
| between . . . ? | “Query”) |
| Supplement? | (“*”, VerbID of verb, “*”, “*”, EntityID of “where”, |
| | “Query”) |
| | (“*”, VerbID of verb, “*”, “*”, EntityID of “when”, |
| | “Query”) |
| | (“*”, VerbID of verb, “*”, “*”, EntityID of “how”, |
| | “Query”) |

Table 1 shows some exemplary tuple templates, each of which comprises a tuple (P1, P2, P3, P4, P5, P6). Each variable P1, P3, P4 and P5 may represent an EntityID, a value “none” or “*” (a wildcard). P2 may represent a VerbID or “*”. P6 represents “Query” for the purposes of this disclosure, and may represent other types of inputs in non-search-related embodiments of the NLPE. To match a tuple (P1, P2, P3, P4, P5, P6) with a tuple (T1, T2, T3, T4, T5, T6), if P is “*”, it can be matched with any value of the corresponding T, i.e. a wildcard. Otherwise, only exact matches with corresponding T values are accepted for a match. Each tuple template also stores the information stating which search type is to be executed if the template is matched.

Referring back to FIG. 5, the known entity search operation 509 may be selected for a natural-language query about an entity that is stated in a noun phrase, e.g. “George Bush”, “table”, or a question in the form of “What/Who is something/someone?” etc. The returned information of the queried entity may be used as a modifier to the main queried entity. For example, the query “Bill who is a composer and lives in Los Angeles” has the main queried entity being “Bill” and the string “who is a composer and lives in Los Angeles” being processed as the given information. The given information is used by the NLPE to clarify the main queried entity that will be represented in the semantic structure of the query. Known entity search operation 509 executes a search on the main entity. For example, given an input query “Who is George Bush?” or “George Bush”, the parse query operation 501 may return a semantic structure including 13 tuples including, for example:

(EntityID of “who”, VerbID of “be”, EntityID of “George H. W. Bush”, “none”, { }, “Query”)

(EntityID of “who”, VerbID of “be”, EntityID of “George W. Bush”, “none”, { }, “Query”)

. . . and so on. The tuple template corresponding to the “Who/What is . . . ?” query may be matched with the semantic structure of the input query. For instance, the matched tuple template may comprise:

(EntityID of “who”, VerbID of “be”, “*”, “none”, “*”, “Query”)

Upon returning the match, the search type determination operation 507 may call the known entity search operation 509. Known entity search operation 509 may return all EntityIDs in the third column of all found tuples as its result set. For example, the result may comprise:

{EntityID of “George H. W. Bush”, EntityID of “George W. Bush”, . . . }

In contrast, the unknown entity search operation 510 may be invoked for an input query that includes a natural-language wh-question on a subject part, e.g. “who killed Bill?” etc. The wh-word (i.e. who, what, where) is the main queried entity and “Bill” is a referenced entity. For example, given a query such as “Who killed President Kennedy?”, the parse query operation 501 may produce the query's semantic structure including 1 tuple comprising:

(EntityID of “who”, VerbID of “kill”, EntityID of “John F. Kennedy”, “none”, { }, “Query”)

A corresponding tuple template from the “Who did/does . . . ?” query type may be matched with the semantic structure of the query. For example, the corresponding tuple template may comprise:

(EntityID of “who”, Verb ID of verb, “*”, “*”, “*”, “Query”)

Given this match, the search type determination operation 507 may call the unknown entity search operation 510. This operation may comprise mapping parts T1, T2 and T3 of a tuple to columns EntityID, VerbID and Value of a relation table, such as table 220 in the KB 106, respectively. T1 represents the EntityID of “who”, and therefore T1 may be the query field. T2 and T3 may be treated as constraint fields. Unknown entity search operation 510 may execute a database search on the relation table with the specified query and constraint fields. All values of the query field of matching records are returned 513 as the result.

Similarly, for a query on a direct object of a clause, such as “Who did Bill ask?”, in method the parse query operation 501, an NLPE may return a semantic structure including 1 tuple comprising, for example:

(EntityID of “Bill”, VerbID of “ask”, EntityID of “whom”, “none”, { }, “Query”)

The tuple template for the “Who/Whom . . . ?” query type may be matched with the semantic structure of the query. For example, the tuple template may comprise:

(“*”, VerbID of verb, EntityID of “whom”, “*”, “*”, “Query”)

Given this match, the search type determination operation 507 may call the unknown entity search operation 510, which will search the relation table in the knowledge base using T1 and T2 as constraint fields, and T3 as the query field. All values of the query field of matching records may be returned 513 as the result. For example, the result may be provided as {EntityID of “Lee Harvey Oswald”, . . . ).

In another example, the relation search operation 511 may be selected for a natural-language query on a verb part of a sentence, e.g. “the relation between Barack Obama and Michelle Obama?”, “What did Bill do to Mary?” etc. For example, given the query “What did Bill do to Mary?”, the parse query operation 501 may execute the NLPE to generate the query's semantic structure including 1 tuple, for example:

(EntityID of “Bill”, VerbID of “do-what”, “EntityID of “Mary”, “none”, { }, “Query”)

The closest tuple template for a “Relation between . . . ” query type may be matched with the semantic structure of the query. The tuple template may comprise, for instance:

(“*”, Verb ID of “do-what”, “*”, “*”, “*”, “Query”)

Given this match, the search type determination operation 507 may call the relation search operation 511, which searches the relation table in the KB using T1 and T3 as constraint fields, and T2 being the query field. All pairs (VerbID, RelationID) of matching records are returned as the method result. For example, the result may comprise {RelationID1, RelationID2, . . . }.

Finally, the supplement search operation 512 may be selected for a natural-language query about the supplement part of a sentence, e.g. “Where does Bill live?”, “When did John arrive?” etc. The search type determination operation 507 may attempt to match the tuple templates of the “Supplement” query type with tuples of the semantic structure retrieved from a query parsing operation 501. If a match is found, the supplement search operation 512 is invoked to search the relation table in the KB using T1, T2 and T3 as constraint fields. All RelationIDs of matching records may be returned as the result. Depending on the EntityID of P5 in the semantic structure of the query, supplement search operation 514 may also retrieve the corresponding part in the supplement field in of matching records as part of its returned result.

Depending on the type of results returned from these steps, the display results operation 513 may display the results in different ways. For example, if the list of entities is returned, then an entity that has the most significant statistical measurement may be returned as the default entity. This operation may comprise searching the Ent/Cat/Rel_Page table 214 of KB 106 (see FIG. 2) to find records having the EntityID of the default entity. All PageIDs of found records are returned as the search results and displayed on the SSE interface. If the list of pairs (VerbID, RelationID) is returned (in the case of a relation search 511), then the display results operation 513 may select the VerbID having the most significant statistical measurement as the default relation. The list of RelationIDs related to the VerbID of the default relation is extracted. From the list of RelationIDs, the Ent/Cat/Rel_Page table 214 may be searched to retrieve records having the matching RelationID in the list. The display result operation 513 shows the VerbID of the default relation and the list of found PageIDs.

As described above, upon processing the query and returning the search results, a plurality of refinement options may be provided to a user to enable further exploration on the main and additional entities and relations. These refinement options may be displayed on the SSE interface. For example, an ambiguity refinement helps the search engine understand the user's intention. When the user enters a query as the name of an entity, that name can refer to several different practical entities, e.g., “Java” referring to an Island in Indonesia or a programming language in computing. When searching a query of “Java”, the SSE finds several entities from the KB that are named “Java” as the query. The search engine selects the most popular entity of the found entities as the default entity, and then displays the default entity as the result. However, the default entity may not be the one the user intends to search. Thus, the ambiguity refinement option provides list of potential matched entities, enabling the user to select the most appropriate entity as the default entity. This user feedback can help to clarify the truly queried entity. The SSE may the use this selected entity as the new default entity for subsequent searches.

Social refinement displays pages/articles/documents related to the default entity that are sourced from social networks. For example, when the default entity is a named entity such as a celebrity or organization that is active on social media, any related accounts from popular social sites may be searched and displayed, such as from Wikipedia, Facebook, LinkedIn, etc. These accounts can be found by provided a programming library of social network sites to the SSE, and may be pre-indexed for the default entity in the KB. Links to social accounts of the default entity are listed in the social refinement display area of the SSE interface.

Feature refinement displays information about the main features or attributes of the default entity for users to discover. A link to one or more listed features enables a user to view detailed information of the default entity. If an entity has too many attributes, main attributes are defined by schemas in the initialization phase of the KB and added by the semantic index process described herein and with reference to FIG. 6.

Similarity refinement displays entities similar to the default entity. For example, when searching for the Java Island in Indonesia, a user may want to search for similar islands in the same country. In the KB, similar entities are entities belonging to the same category with the default entity, so that they have the same main attributes with the default entity. In practice, there are too many entities in a category, so that in one implementation, the set of most related entities to the default entity may be retrieved and indexed by the indexing module.

Association refinement displays several entities that are related to or associated with the default entity. In the KB, an entity may have its “own” and “popular” relations with other entities. The “own” tag refers those entities belonging to the same category and having different relations. The “popular” tag indicates that certain relations of an entity are more popular than others. The relations of an entity are discovered and added to the KB by indexing operations. Only stored relations are displayed in the association refinement area of the SSE interface. This refinement can help the user discover the relation of the default entity and build a context around the default entity. This refinement enriches the search by semantic relations. For example, when searching of Java island, a user may want to know about main persons or events that are strongly related to the Java island.

When searching an entity as a general concept, specific refinement provides the user with options to explore specific types of the default entity. This refinement can narrow the search process of the user. For example, when a user searches for “apple”, he/she may want to know more about some particular types of “apple”, e.g., “table apple” or “ripe apple”. Similarly, general refinement enables the user to explore more general types of the default entity. This refinement can make the search process broader. For example, when a user searches for “Java (Programming Languages)”, he/she may search about more general types of programming languages, e.g., “Object-Oriented Programming”, “Cross-Platform Languages”.

As described above, the search results may be ranked using a ranking function or module based on a well-known factor of a page and a semantic related measurement between a queried entity/relation and a page. The well-known factor of a page is independent with the query, so it is stored in a database of page address. The related measurement between a query and a page is stored as a meta-data of the index from an entity or a relation to a document. Specific factors used by the ranking module may include the following: within the well-known factor of a page, a popularity R_{P} representing highly-accessing web sites over a long time period, a hotness R_{H} representing highly-accessing web sites over a recent time period, a trust R_{T} representing well-edited web sites, such as text books, encyclopedias, dictionaries, etc., and within the related measurement between a query and a page: a correlation R_{C} representing an account of how the content of the page directly describes the queried entity, a richness R_{R} accounting for a number of features and entities related to the queried entity/relation mentioned in the document, a user selection (on the search results) R_{U} representing the relative correlation with other results in the same result page of the queried entity/relation, and a user evaluation R_{V} representing recommendations of trusted or highly influential users, e.g., domain experts, scientists, etc.

Given these factors, a semantic ranking function may be defined using the following equation:

R=a₁R_{P}+a₂R_{H}+a₃R_{T}+a₄R_{C}+a₅R_{R}+a₆R_{U}+a₇R_{V}

where aᵢ, i=1 to 7 are float numbers, and

$${\sum }_{i = 1}^{7} {α}_{i} = 1$$

The selection of values for aᵢ may vary for different embodiments. For example, the value of aᵢ may change depending on the natural language being processed, current search trends, etc.

Moreover, some interesting search results of the found entity may be tagged with one or more modifiers. For example, returned links having a high value of popularity, are tagged as “Popular”. Other returned links that have a high value of hotness, are tagged as “Updated”. In addition, some other returned links that have a high value of trust, are tagged as “Trusted.”

FIG. 6 describes a method for indexing, according to an exemplary embodiment of the subject disclosure. Although discrete steps and modules are shown, the operations described herein may be paired or grouped differently depending upon the source sentence/query, or may be performed in a different order, so long as the inventive scope and spirit is preserved. Indexing method 600 may begin with an initialization 601 of an initialized knowledge base (KB) 602 by retrieving external semantic resources 621. External semantic resources 621 may comprise search engine's query logs, linked open data (LODs), and other semantic resources, e.g. Wikipedia, Freebase, DBpedia, WordNet and Dictionary. The initialized KB 602 has a similar data structure scheme as the KB shown in FIG. 2. Moreover, the initialized KB 602 may also be manually edited in some embodiments. Further, in addition to entities being imported from external semantic resources 621, a list of alias names is also constructed for each entity and category. The relations between entities, between entities and categories and between categories are imported into the initialized KB 602.

A corpus of documents 622, which is crawled from the Internet, may be accessed by an analyze documents 603 operation, which comprises analyzing each document to find its title and main information, e.g., author, publication date, leading phrase, etc. The document structure, i.e. a tree of sections, is also extracted in this phase. Sentences within documents may be submitted to the NLPE for retrieval of a semantic structure comprising a set of tuples, as described herein. The set of tuples may be submitted to an update KB operation 604, which uses the tuples to create indices from entities or relations within the retrieved document. For example, each tuple (T1, T2, T3, T4, T5, T6) results in four indices that are created and inserted to the Ent/Cat/Rel_Page table 214 in the KB 106. These four indexes include index I1, I2, I3 and I4 from T1, T2, T3 and T4 to document D, respectively. The tuple is also used to create a record in a relation table, such as table 220 in KB 106. The RelationID of the created record is used to create the fifth index from the Relation ID to document D.

In addition, update KB operation 604 uses the tuples to update the KB 606. The probability of entities and relations in the KB 606 is updated by the set of tuples for each retrieved document. Periodically, entities and relations with a low probability are removed from KB 606. Entities and relations that exist in semantic statements and have not yet existed in KB 606 are stored in a list of candidates. Periodically, potential entities and relations are selected from this candidate list to add to KB 606. Finally, an extract alias names operation 607 is executed to retrieve all alias names from a name table, such as table 202 in KB 106, to create a name dictionary 613. The name dictionary 613 is used to recommend users to type correct entity/relation names during input of a query on an SSE interface.

Therefore, the disclosed methods can process sentences and phrases and provide meaningful analyses and results that take into account the clause structure of a sentence (stored in the phrase-level syntactic structure), determining a meaning of a query, and constantly refining results in real time and based on user input. These improvements overcome existing methods that use brute-force methods to search phrases and components of clauses without considering an overall context or complexity of a query, or those that fail to provide refinements in real-time while constantly updating a knowledge base. For instance, existing methods that that combine keyword searches with syntactic annotations may only process pairs of terms such as a subject followed by a verb, or a verb followed by an object, etc., which is a severe limitation when contrasted with the disclosed templates for various types of queries and the indexing system for processing and storing syntactic structures within documents. These systems fail to process natural-language queries and only accept Boolean expressions of terms or types.

While the above description contains much specificity, these should not be construed as limitations on the scope of any embodiment, but as exemplifications of the presently preferred embodiments thereof. Many other ramifications and variations are possible within the teachings of the various embodiments. Moreover, although the templates have been described with reference to the English language, persons having ordinary skill in the art may be motivated in light of this disclosure to adapt the templates to various other dialects and languages without departing from the inventive scope and spirit of the disclosed operations. Thus the scope of the subject disclosure should be determined by the appended claims and their legal equivalents, and not by the examples given.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed is:

1. A system for parsing a natural-language query and searching web documents, the system comprising:
a server; and
a memory coupled to the server, the memory to store logical instructions that are executed by the processor to perform operations comprising:
parsing a received query to create a semantic structure of the query;
identifying one or more queried entities or queried relations within the semantic structure;
retrieving one or more matching entities or relations based on a comparison of the semantic structure with a knowledge base;
selecting one entity or relation from the one or more matching entities or relations as a default entity or default relation based on a statistical measurement; and
retrieving a plurality of search results based on the default entity or relation.

2. The system of claim 1, wherein the operations further comprise executing a natural language processing engine (NLPE) to generate the semantic structure of the query.

3. The system of claim 1, wherein the operations further comprise ranking the plurality of search results based on a semantic ranking function.

4. The system of claim 3, wherein the ranking is based in part on a combination of a well-known factor of a page and a semantic-related measurement between the one or more queried entities or queried relations and the page.

5. The system of claim 3, wherein the operations further comprise displaying the plurality of search results with a corresponding plurality of semantic tags.

6. The system of claim 1, wherein the operations further comprise displaying one or more refinements on a search interface, the one or more refinements being based on an analysis of one or more of the default entity or default relation.

7. The system of claim 6, wherein the one or more refinements comprise one or more of an ambiguity refinement, a social refinement, a similarity refinement, a specific refinement, or a general refinement.

8. The system of claim 7, wherein the ambiguity refinement comprises displaying the default entity as a found entity, and displaying a list of ambiguous entities that are similarly named to the default entity.

9. The system of claim 7, wherein the social refinement comprises searching for social media pages of the default entity and displaying links to the social media pages along with the plurality of search results.

10. The system of claim 7, wherein the similarity refinement comprises searching for and displaying entities similar to the default entity.

11. The system of claim 7, wherein the specific refinement comprises searching for and displaying entities that are more specific than the default entity.

12. The system of claim 7, wherein the general refinement comprises searching for and displaying entities that are more general than the default entity.

13. The system of claim 1, further comprising identifying a query type based on a comparison of the semantic structure of the query with a plurality of commonly-asked question templates.

14. The system of claim 1, wherein the operations further comprise comparing the queried entity or relation with the knowledge base using one or more constraint entities or constraint relations.

15. The system of claim 1, wherein the retrieval of the plurality of search results is based in part on an index linking an entity, a relation, or a category, with a web address.

16. A method for constructing a knowledge base, comprising:
initializing the knowledge base with a plurality of external semantic resources;
constructing an indexing database to link one or more entities retrieved from the plurality of external semantic resources; and
at regular intervals, updating the knowledge base using an indexing process.

17. The method of claim 16, wherein constructing the indexing database further comprises:
parsing a document to retrieve a semantic structure of the document; and
generating a plurality of indices based on one or more of an entity, a category, or a relation within the semantic structure of the document.

18. The method of claim 16, wherein the updating the knowledge base using the indexing process further comprises:
updating any existing entities and relations in the knowledge base;
storing non-existing entities and relations as a list of candidates; and
adding to the knowledge base any non-existing entities and relations that have a high occurrence within the list of candidates.

19. A non-transitory computer-readable medium for storing computer-executable instructions that are executed by a processor to perform operations comprising:
parsing a received query to create a semantic structure of the query;
identifying one or more queried entities or queried relations within the semantic structure;
retrieving one or more matching entities or relations based on a comparison of the semantic structure with a knowledge base;
selecting one entity or relation from the one or more matching entities or relations as a default entity or default relation based on a statistical measurement; and
retrieving a plurality of search results based on the default entity or relation.

20. The computer-readable medium of claim 19, wherein the operations further comprise:
ranking the plurality of search results based on one or more of a well-known factor and a semantic relationship of entities within the page.
